(19) United States
(12) Patent Application Publication
(10) Pub. No.: US 2023/0177612 A1
(43) Pub. Date: Jun. 8, 2023

(54) DYNAMIC MICRO-INSURANCE PREMIUM VALUE OPTIMIZATION USING DIGITAL TWIN BASED SIMULATION

(71) Applicant: INTERNATIONAL BUSINESS MACHINES CORPORATION, ARMONK, NY (US)

(72) Inventors: Craig M. Trim, Ventura, CA (US); Shikhar Kwatra, San Jose, CA (US); Kuntal Dey, Rampurhat (IN); Seema Nagar, Bangalore (IN)

(21) Appl. No.: 17/457,283

(22) Filed: Dec. 2, 2021

(51) Int. Cl. G06Q 40/08; G06F 30/20; G06Q 20/38

(52) U.S. Cl. CPC G06Q 40/08; G06F 30/20; G06Q 20/389; G06F 2111/08

(57) ABSTRACT

A method, computer system, and a computer program product for determining micro-insurance premium values is provided. The present invention may include generating a digital twin based on an object identified by a user. The present invention may include modifying the digital twin using data received from the object identified by the user. The present invention may include simulating a performance of the modified digital twin in a plurality of conditions. The present invention may include determining a micro-insurance premium value for the object.

### BACKGROUND

The present invention relates generally to the field of computing, and more particularly to digital twins.

Micro-insurance may be a type of insurance designed to make insurance products more affordable based on specific needs of a user. Micro-insurance may be utilized in various situations, such as, but not limited to, short time period events, one-time events, specific needs, amongst other various situations. Currently, micro-insurance premium values may be determined by predicting the health of an object and/or entity over a specified time period. These health predictions of the object and/or entity to be covered by the micro-insurance may be mapped to a financial value of the object and/or entity to determine an insurance premium value for the specified period of time.

Predicting the health of the object and/or entity over the specified time period may require considering and/or simulating a plurality of factors which may complicate the determination of the insurance premium value.

### SUMMARY

Embodiments of the present invention disclose a method, computer system, and a computer program product for micro-insurance. The present invention may include generating a digital twin based on an object identified by a user. The present invention may include modifying the digital twin using data received from the object identified by the user. The present invention may include simulating a performance of the modified digital twin in a plurality of conditions. The present invention may include determining a micro-insurance premium value for the object.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for determining micro-insurance premium values according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for micro-insurance. As such, the present embodiment has the capacity to improve the technical field of micro-insurance by determining micro-insurance premium values using digital twin simulations. More specifically, the present invention may include generating a digital twin based on an object or entity identified by a user. The present invention may include modifying the digital twin using data received from the object or entity identified by the user. The present invention may include simulating a performance of the modified digital twin in a plurality of conditions. The present invention may include determining a micro-insurance premium value for the object or entity based on at least the performance of the modified digital twin in the plurality of conditions.

As described previously, micro-insurance may be a type of insurance designed to make insurance products more affordable based on specific needs of a user. Micro-insurance may be utilized in various situations, such as, but not limited to, short time period events, one-time events, specific needs, amongst other various situations. Currently, micro-insurance premium values may be determined by predicting the health of an object and/or entity over a specified time period. These health predictions of the object and/or entity to be covered by the micro-insurance may be mapped to a financial value of the object and/or entity to determine an insurance premium value for the specified period of time.

Predicting the health of the object and/or entity over the specified time period may require considering and/or simulating a plurality of factors which may complicate the determination of the insurance premium value.

Therefore, it may be advantageous to, among other things, generate a digital twin based on an object or entity identified by a user, modify the digital twin using data received from the object or entity identified by the user, simulate a performance of the modified digital twin in a plurality of conditions, and determine a micro-insurance premium value for the object or entity based on at least the performance of the modified digital twin in the plurality of conditions.

According to at least one embodiment, the present invention may improve the accuracy of micro-insurance premium values by simulating a performance of a digital twin in a plurality of conditions.

According to at least one embodiment, the present invention may improve the micro-insurance payments between a user and insurance provider by utilizing smart contracts in incentivizing recommended actions by the user during an insurance time period.

According to at least one embodiment, the present invention may improve the accuracy of micro-insurance premium values by simulating a performance for each of a plurality of parts comprising an object and/or entity and weighting the probability of each potential state for a part in the micro-insurance premium value determination.

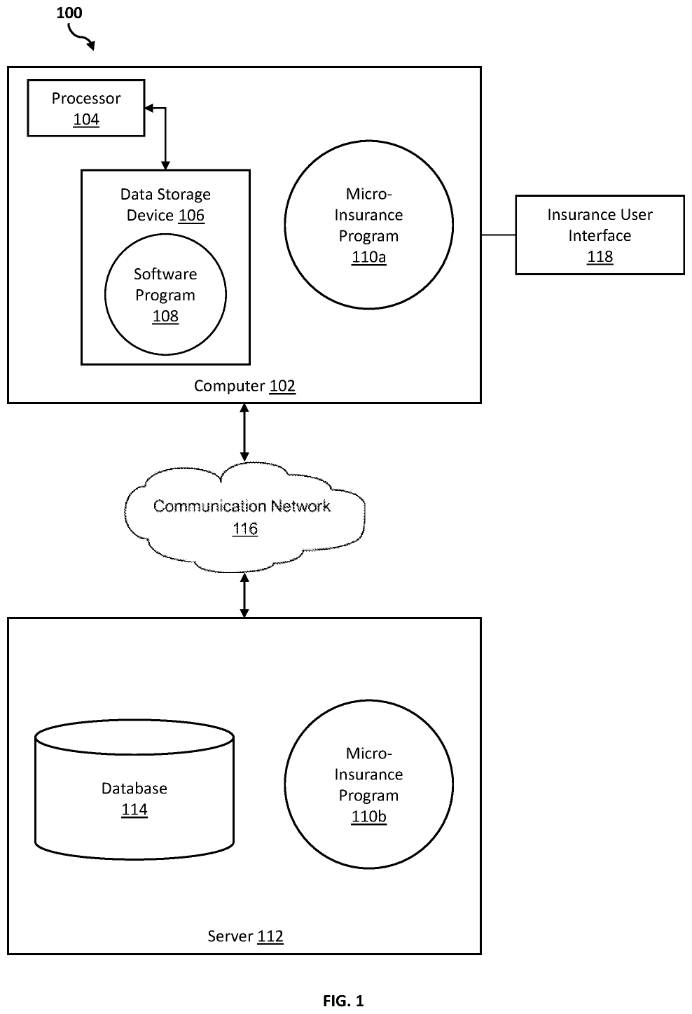

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a micro-insurance program 110a. The networked computer environment 100 may also include a server 112 that is enabled to run a micro-insurance program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

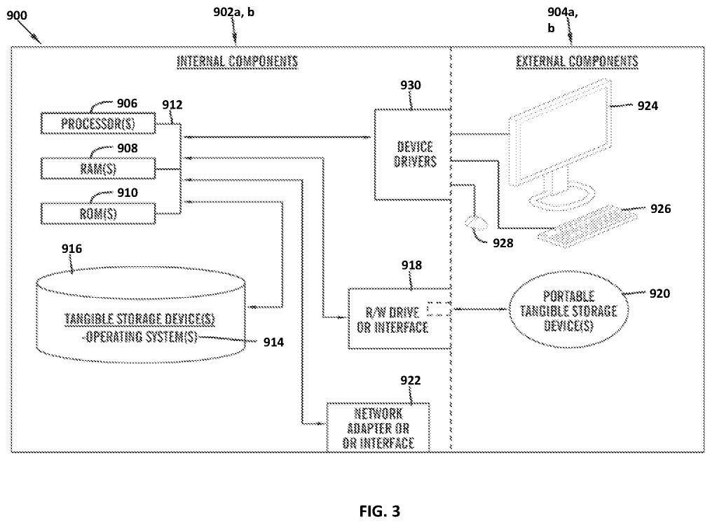

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the micro-insurance program 110a, 110b may interact with a database 114 that may be embedded in various storage devices, such as, but not limited to a computer/mobile device 102, a networked server 112, or a cloud storage service.

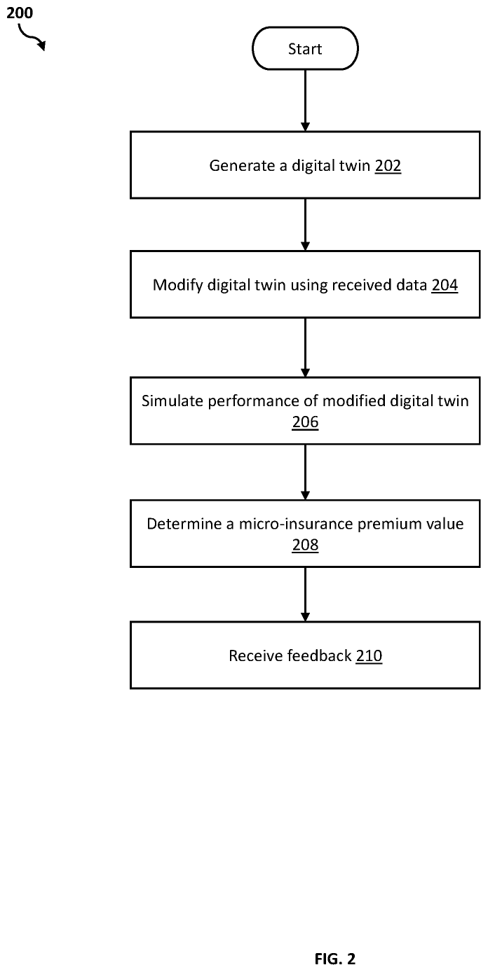

According to the present embodiment, a user using a client computer 102 or a server computer 112 may use the micro-insurance program 110a, 110b (respectively) to determine micro-insurance premium values using digital twin simulations. The determining micro-insurance premium values method is explained in more detail below with respect to FIG. 2.

Referring now to FIG. 2, an operational flowchart illustrating the exemplary micro-insurance process 200 used by the micro-insurance program 110a and 110b (hereinafter micro-insurance program 110) according to at least one embodiment is depicted.

At 202, the micro-insurance program 110 generates a digital twin. The micro-insurance program 110 may generate the digital twin based on an object and/or entity identified by a user. A digital twin may be a digital representation of at least an object, entity, and/or system that spans the object, entity and/or system's lifecycle. The digital twin may be updated using real time data, and may utilize, at least, simulation, machine learning, and/or reasoning in aiding informed decision making.

The user may identify the object and/or entity in an insurance user interface 118. The insurance user interface 118 may be displayed by the micro-insurance program 110 in at least an internet browser, dedicated software application, and/or as an integration with a third party software application. The micro-insurance program 110 may receive and/or access data with respect to the object and/or entity identified by the user from at least a knowledge corpus (e.g., database 114), amongst other sources.

For example, the user may identify a car (e.g., the object or entity in this example) in which the user would like to insure through the micro-insurance program 110. The user may identify the car within the micro-insurance user interface 118. The micro-insurance program 110 may access data stored for the car within the knowledge corpus (e.g., database 114), such as, but not limited to, product configuration, materials used, manufacturing/process parameters, service history, diagnostics data, vehicle modifications, odometer readings, telematics data, recall campaigns, product details, accident reports, amongst other data stored for the car within the knowledge corpus (e.g., database 114). The micro-insurance program 110 may generate the digital twin for the car identified by the user based on at least the data accessed from the knowledge corpus (e.g., database 114). As will be explained in more detail below with respect to step 204, the micro-insurance program 110 may modify the digital twin based on data received regarding the object and/or entity.

At 204, the micro-insurance program 110 modifies the digital twin based on data received from the object and/or entity corresponding to the digital twin. The micro insurance program 110 may receive data from at least one or more Internet of Things (IoT) devices associated with the object and/or entity corresponding to the digital twin. The micro-insurance program 110 may modify the digital twin once a data threshold has been reached and/or exceeded.

The data received from the at least one or more IoT devices associated with the object and/or entity corresponding to the digital twin may be utilized in learning actions of the object and/or entity. The micro-insurance program 110 may translate the actions of the object and/or entity into a state graph, wherein each node of the state graph may represent an action taken and each edge may be directed from one node to another, which may mark the probability of an entailing action being carried out, given the preceding action. In determining the probability of the entailing action being carried out, given the preceding action, the micro-insurance program 110 may utilize the following equation:

|e(s1→s2)|=p(s2|s1)

In the above equation, a first action state may be denoted by s1 and a second action state may be denoted by s2, the directed edge from s1 to s2 may represent the transition probability of the system to be in action state s2 from it being in action state s1 at the preceding state.

Continuing with the example above in which the user identified the car through the micro-insurance user interface 118, here, the data received may be from at least one or more IoT devices of the car as well as other data received from the car corresponding to the digital twin. The micro-insurance program 110 may utilize the data received to learn the driving actions of the user and/or modify the digital twin based on the actions of the car. As will be explained in more detail below, if the user frequently accelerates and utilizes the breaks, then the micro-insurance program 110 may determine an increased probability of the breaks transitioning to a potential state such as a replacement state.

The data threshold for the actions of the object and/or entity may depend on various factors, such as, but not limited to, the object and/or entity identified by the user, previous data received from the user, amongst other factors. The micro-insurance program 110 may iteratively reduce the data threshold for an object, entity, and/or user as simulations are performed and feedback received over time.

At 206, the micro-insurance program 110 simulates a performance for the modified digital twin in a plurality of conditions. The micro-insurance program 110 may simulate potential ambient conditions the object and/or entity may go through during a time period in which the user may be covered by insurance. The micro-insurance program 110 may utilize one or more forecasting machine learning models in simulating the performance for the modified digital twin.

The one or more forecasting machine learning models utilized by the micro-insurance program 110 may include at least a Monte Carlo simulation process. The micro-insurance program 110 may additionally utilize a statistical program such as IBM's SPSS® (SPSS® and all SPSS-based are trademarks or registered trademarks of International Business Machines Corporation in the United States, and/or other countries), or Statistical Product and Service Solution, in optimizing the Monte Carlo simulation process.

The micro-insurance program 110 may determine a probability of the object and/or entity reaching each of a plurality of potential states by simulating the modified digital twin utilizing the one or more machine learning models and determining a number of times each potential state is achieved. The micro-insurance program 110 may perform the simulation for each part which may comprise the object and/or entity. The micro-insurance program 110 may compute the whole as a function of all the parts, such that the micro-insurance premium value for the object and/or entity for the time period may be based on the sum of the reduction in monetary value of all the plurality of parts comprising the object and/or entity. For example, the user may identify a car as the object which the user would like to insure through the micro-insurance program 110. The car which the user would like to insure may be comprised of 100 parts. The micro-insurance program 110 may modify the digital twin for the user's car based on the data received from at least the one or more IoT devices associated with the user's car. Accordingly, the modified digital twin may be comprised of the 100 parts of the car as described above. A proceeding state may be a current state of each part as it exists in the user's car. In this example, Part 1 may be the car battery, Part 2 may be the brakes, Part 3 may be the axle, and Part 4 may be the spark plug. Based on the data received from the one or more IoT devices associated with the user's car and the data accessed from the knowledge corpus (e.g., database 114), the micro-insurance program 110 may determine a proceeding state of 80% health for Part 1, 100% health for Part 2, 100% health for Part 3, and 90% health for Part 4. If the user would like to insure the car for a week, the micro-insurance program 110 may simulate the modified digital twin in the plurality of conditions for a week. In each simulation, the micro-insurance program 110 may identify the potential state in which each part transitioned. As will be explained in more detail below, the micro insurance program may utilize a financial equivalence mapping to determine the monetary value for each part in each of the plurality of potential states. Here, the micro-insurance program 110 may compute the micro-insurance premium value as a function of the 100 parts comprising the user's car, such that the micro-insurance premium value would be the sum of the reduction in monetary values of each of the 100 parts comprising the user's car.

In an embodiment the function parts may be the sum. In other embodiments the function of all the parts may include complex interplay between the plurality of parts. The complex interplay between the plurality of parts may be specified by at least domain experts and/or external knowledge in these embodiments.

The plurality of parts comprising the object and/or entity may be represented as follows:

P={p1,p2, . . . ,pn}

The potential state for each part may be represented as follows:

Sp={sp,1,sp,2, . . . ,sp,m}

In the above equation m may represent any additional meta-information available to the micro-insurance program 110. The micro-insurance program 110 may utilize the meta-information in overlaying the probabilities of each potential state. For example, if calendar event information is made available by the user to the micro-insurance program, then the probability value may be overwritten to guarantee a potential state of the object and/or entity such that the potential state of a part may be 1 and the other potential states for the part may be 0.

The probability (e.g., normalized likelihood) P of a part pi reaching a potential state sj from a preceding state si for a simulation of part pi may be determined by the micro-insurance program 110 utilizing the following equation:

$$P ( pi , sj ) = ( \frac{count ( si )}{total number of simulations} ) * P ( sj \vert si )$$

The micro-insurance program 110 may determine the probability P (e.g., normalized likelihood) for each of part pi, of the plurality of parts comprising the object and/or entity, of transitioning to each potential state sj. The probability P (sj|si) may be determined for all incoming edges e(si→sj) towards sj. The micro-insurance program 110 may repeat the above process for each of the plurality of parts, generating a matrix of the probabilities of each part pi transitioning to each potential state sj. The micro-insurance program 110 may determine the probability of transitioning to each potential state sj for each of the plurality of parts, wherein the probability P acts as a weight on a total impact of the weighted sum of each of the plurality of parts comprising the object and/or entity.

The plurality of conditions utilized by the micro-insurance program 110 may be based on external data sources as well as the data received from the at least one or more IoT devices associated with the object and/or entity which may have been used to generate the digital twin. The micro-insurance program 110 may simulate likely driving conditions for the time period in which the user may be covered by the insurance. For example, User 1 may have identified Vehicle 1 in the insurance user interface 118 and User 2 may have identified Vehicle 2 in the insurance user interface 118. In this example, Vehicle 1 and Vehicle 2 may be the same make and model of a vehicle with the same amount of mileage, both User 1 and User 2 may have brand new brake pads. In this example, brake pads may be Part 1 for Vehicle 1 and Part 1 for Vehicle 2, each starting in a 100% health state. While both User 1 and User 2 may be looking to insure their vehicles on a month to month time period, User 1 may be located in an area with adverse weather conditions and high traffic while User 2 may be located in an area with consistent weather conditions and little traffic. Additionally, micro-insurance program 110 has learned the driving actions of both User 1 and User 2 based on the IoT data received from their respective vehicles. User 1 in this case may frequently apply the breaks due to high traffic during User 1's driving times while User 2 rarely applied the break during the data gathering stage. Accordingly, during the simulation of Vehicle 1's performance for the month, Part 1 transitioned from a 100% healthy state to a 90% healthy state in five simulations, 80% healthy state in three simulations, and a 70% healthy state in two simulations. As will be explained in more detail below, the brake pads may have a value of $100 dollars at a 100% healthy state, $90 dollars at a 90% healthy state, $80 dollars at an 80% healthy state, and $70 at a 70% healthy state. Accordingly, in the 10 simulations performed for Vehicle 1 there were 5 simulations in which Part 1 lost $10 dollars of value, 3 simulations in which Part 1 lost $20 dollars of value, and 2 simulations in which Part 1 lost $30 dollars in value, so the micro-insurance program 110 may utilize a premium value of $17 for Part 1 of Vehicle 1 in determining the micro-insurance premium value for the month for User 1. In the simulations of Vehicle 2, the brake pads may have remained in an 100% healthy state for 9 simulations and transitions to a 90% health state in just 1 simulation. Accordingly, the micro-insurance program 110 may utilize a premium value of just $1 dollar for Part 1 of Vehicle 2 in determining the micro-insurance premium value for the month for User 2.

At 208, the micro-insurance program 110 determines a micro-insurance premium value for a time period. The micro-insurance program 110 may determine the micro-insurance premium value based on at least the performance of the modified digital twin in the plurality of conditions and a financial equivalence mapping.

The financial equivalence mapping may include at least a monetary value for each of the plurality of parts comprising the entity and/or object in each of the one or more potential states. The micro-insurance program 110 may access the financial equivalence mapping from the knowledge corpus (e.g., database 114) and/or receive the financial equivalence mapping from at least, one or more of, a domain expert, organizational database, and/or third party e-commerce website, amongst other sources.

The micro-insurance program 110 may utilize the following equation in determining the micro-insurance premium value for the time period:

dr=sj of pi to MV*P(pi,sj) for pi summed for all pi and all sj

In the above equation, dr may represent the micro-insurance premium value for the time period based on mapping each potential state sj for each of the plurality of parts pi to the monetary value MV of the financial equivalence mapping. The micro-insurance program 110 may multiply the monetary value MV for each potential state sj by the probability of transitioning to state sj for the part pi. In the above equation, the probability value may act as a weighting, with a total impact being a weighted sum of individual impacts for each of the plurality of parts comprising the object and/or entity.

In an embodiment, the micro-insurance program 110 may utilize a blockchain payment method in charging the micro-insurance premium value to the user. The micro-insurance program 110 may also generate one or more smart contracts between the user and an insurance provider. A smart contract may be a program stored on a blockchain that executes upon the fulfillment of predetermined conditions. As will be explained in more detail below with respect to step 210, the micro-insurance program 110 may include incentives and/or recommendations to the user which may reduce the micro-insurance premium value for the time period and/or credit the user's account. The one or more smart contracts generated by the micro-insurance program 110 may be presented to the user in the insurance user interface 118.

At 210, the micro-insurance program 110 receives performance feedback from the object and/or entity of the user. The micro-insurance program 110 may receive the performance feedback intermittently throughout the time period of which the micro-insurance premium value covers the object and/or entity and/or at the end of the time period.

In an embodiment, the micro-insurance program 110 may utilize at least the micro-insurance premium value determined at step 208 and the performance feedback from the object and/or entity in improving the one or more forecasting machine learning models utilized in simulating the performance of the modified digital twin. The micro-insurance program 110 may utilize the performance feedback by correlating the one or more forecasting models with the performance feedback. If a potential state is appropriately predicted, the micro-insurance program 110 may weight the observed transition with an additional weightage factor α (>1) as the most likely transition, and the micro-insurance program 110 may proportionally reduce the weightage factor by δ, where δ may be less than α. The ratio of α to δ may be predetermined and/or the values specified.

The micro-insurance program 110 may utilize the performance feedback received from the object and/or entity in providing one or more recommendations to the user. The one or more recommendations to the user may include incentives and/or recommendations to the user which may reduce the micro-insurance premium value for the user. In one example, the micro-insurance program 110 may utilize the Global Positioning System (GPS) of a vehicle of the user to recommend one or more alternative routes. The one or more alternative routes may be recommended based on performance simulations of the modified digital twin using these alternative routes. The micro-insurance program 110 may also determine a financial incentive for the user driving the one or more alternative routes.

In another embodiment, the micro-insurance program 110 may generate one or more smart contracts which the user may accept in the insurance user interface 118. For example, the micro-insurance program may determine based on the IoT data received at step 204 and/or the performance feedback received from the object and/or entity that the user periodically drives at speeds above 75 miles per hour. The micro-insurance program 110 may generate a smart contract offering the user a $10 dollar premium off the user's micro-insurance premium value for the next month if the user does not exceed 75 miles per hour. The micro insurance program 110 may monitor the speed of the car through data received from the car, and at the end of the month, the smart contract will automatically credit the user if the speed is not exceeded.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the micro-insurance program 110a in client computer 102, and the micro-insurance program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the micro-insurance program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the micro-insurance program 110a in client computer 102 and the micro-insurance program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the micro-insurance program 110a in client computer 102 and the micro-insurance program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

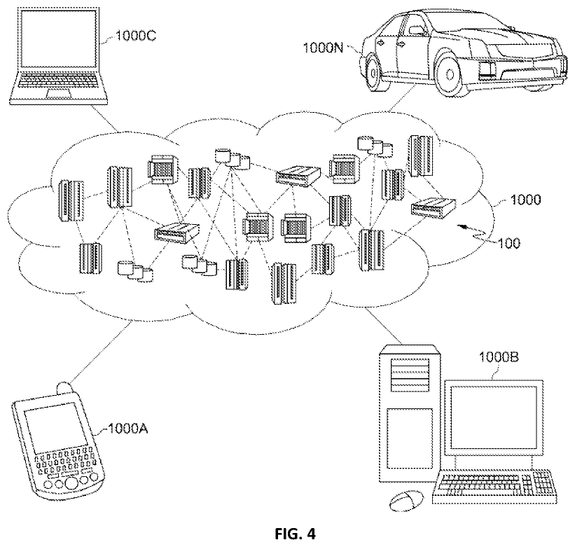

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

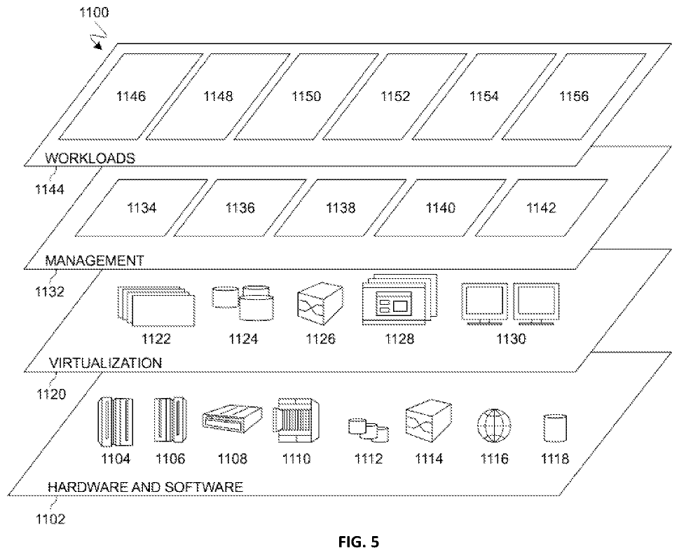

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components.

Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and micro-insurance program 1156. A micro-insurance program 110a, 110b provides a way to determine micro-insurance premium values using digital twin simulations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for determining micro-insurance premium values, the method comprising:
generating a digital twin based on an object identified by a user;
modifying the digital twin using data received regarding the object identified by the user;
simulating a performance of the modified digital twin in a plurality of conditions; and
determining a micro-insurance premium value for the object.

2. The method of claim 1, wherein the digital twin is generated based on data accessed from a knowledge corpus.

3. The method of claim 1, wherein simulating the performance of the modified digital twin further comprises:
utilizing a Monte Carlo simulation process.

4. The method of claim 1, wherein the micro-insurance premium value is determined based on the performance of the modified digital twin in the plurality of conditions and a financial equivalence mapping.

5. The method of claim 4, wherein the financial equivalence mapping includes at least a monetary value for each of a plurality of parts comprising the object in each of one or more potential states.

6. The method of claim 1, further comprising:
receiving performance feedback from the object during a time period of insurance coverage; and
providing one or more recommendations to the user based on the performance feedback, wherein the one or more recommendations reduce the micro-insurance premium value.

7. The method of claim 1, wherein the micro-insurance premium value is charged to the user utilizing a blockchain payment method.

8. The method of claim 7, further comprising:
generating one or more smart contracts between the user and an insurance provider, wherein the one or more smart contracts are comprised of incentives to reduce the micro-insurance premium value for the user.

9. A computer system for determining micro-insurance premium values, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a digital twin based on an object identified by a user;
modifying the digital twin using data received regarding the object identified by the user;
simulating a performance of the modified digital twin in a plurality of conditions; and
determining a micro-insurance premium value for the object.

10. The computer system of claim 9, wherein the digital twin is generated based on data accessed from a knowledge corpus.

11. The computer system of claim 9, wherein simulating the performance of the modified digital twin further comprises:
utilizing a Monte Carlo simulation process.

12. The computer system of claim 9, wherein the micro-insurance premium value is determined based on the performance of the modified digital twin in the plurality of conditions and a financial equivalence mapping.

13. The computer system of claim 12, wherein the financial equivalence mapping includes at least a monetary value for each of a plurality of parts comprising the object in each of one or more potential states.

14. The computer system of claim 9, further comprising:
receiving performance feedback from the object during a time period of insurance coverage; and
providing one or more recommendations to the user based on the performance feedback, wherein the one or more recommendations reduce the micro-insurance premium value.

15. The computer system of claim 9, wherein the micro-insurance premium value is charged to the user utilizing a blockchain payment method.

16. The computer system of claim 15, further comprising:
generating one or more smart contracts between the user and an insurance provider, wherein the one or more smart contracts are comprised of incentives to reduce the micro-insurance premium value for the user.

17. A computer program product for determining micro-insurance premium values, comprising:
one or more non-transitory computer-readable storage media and program instructions stored on at least one of the one or more tangible storage media, the program instructions executable by a processor to cause the processor to perform a method comprising:
generating a digital twin based on an object identified by a user;
modifying the digital twin using data received regarding the object identified by the user;
simulating a performance of the modified digital twin in a plurality of conditions; and
determining a micro-insurance premium value for the object.

18. The computer program product of claim 17, wherein the micro-insurance premium value is determined based on the performance of the modified digital twin in the plurality of conditions and a financial equivalence mapping.

19. The computer program product of claim 18, wherein the financial equivalence mapping includes at least a monetary value for each of a plurality of parts comprising the object in each of one or more potential states.

20. The computer program product of claim 17, further comprising:
receiving performance feedback from the object during a time period of insurance coverage; and
providing one or more recommendations to the user based on the performance feedback, wherein the one or more recommendations reduce the micro-insurance premium value.
